(19) United States
(12) Patent Application Publication
(10) Pub. No.: US 2015/0282464 A1
(43) Pub. Date: Oct. 8, 2015

(54) ARTIFICIAL FISH LURES AND METHODS

(71) Applicant: Robert Allen Brink, Kingwood, TX (US)

(72) Inventor: Robert Allen Brink, Kingwood, TX (US)

(21) Appl. No.: 14/671,866

(22) Filed: Mar. 27, 2015

Related U.S. Application Data
(60) Provisional application No. 61/974,763, filed on Apr. 3, 2014.

(51) Int. Cl. A01K 85/00; A01K 99/00

(52) U.S. Cl. CPC A01K 85/00; A01K 99/00

(57) ABSTRACT

An artificial gamefish lure has a negatively buoyant body and a bill attached to a front of the lure body. The bill extends forward and upward of the lure body. The lure is configured to sink in water until a horizontal force pulls the lure forward. The body can be configured to sink in fresh water at a rate of 30.5 cm in 2-5 seconds. The bill can be mounted on an axis on the top front of the lure body at an angle between 25 and 35 degrees from the longitudinal axis of the lure body and extending forward and upward from the front of the lure body. The proportion of a bill width to a lure body width 52 can be in the range of 0.8:1 to 1.3 to 1 and the proportion of a bill length to lure body length can be in the range of 0.2:1 to 0.7 to 1.

### CROSS-REFERENCE TO RELATED APPLICATION

This application claims the benefit of U.S. Provisional Patent Application No. 61/974,763, filed Apr. 3, 2014, the disclosure of which is incorporated herein by reference in its entirety.

### FIELD

The embodiments herein relate generally to equipment configured to catch game fish, and particularly to artificial fishing lures and methods used to catch game fish, which mimic the natural movements of a baitfish when pulled along through the water by a user.

### BACKGROUND

Game fish are saltwater or freshwater fish that are pursued for sport by recreational fisherman. Freshwater game fish, at least in North America, can include: redfish, salmon, trout, bass, pike, catfish, walleye, crappie, perch, rock bass, bluegill and sunfish. Game fish, such as a large-mouth bass, typically feed on small fish. These small fish can be used as bait by the fisherman to attract the larger predatory game fish.

Many game fish have eyes located primarily on the upper part of their head making it difficult for them to look in a downward direction. Thus, when game fish are feeding, they typically look upwards to see a baitfish or orient its body vertically or inverts itself to allow a greater field of view.

Artificial fish lures are known in the art to attempt to mimic baitfish. Some artificial lures are configured to sink and sit on the bottom of the game fish's environment (See generally, US Pub. 2005/0246940 to Jones et al.). Other lures are configured to float on the surface of the water. Some lures are steerable by a user (See generally, U.S. Pat. No. 8,146,288 to Barczak et al.). Others can orient the body of the lure to a horizontal orientation (See generally, US Pub. 2004/0107626 to Mueller); or even mimic a swimming motion of the baitfish (See generally U.S. Pat. No. 6, 385,896 to Thomassin).

Despite these advances in the art, further advancements are possible and desired.

### SUMMARY

The embodiments herein relate generally to equipment configured to catch game fish, and particularly to artificial fishing lures and methods used to catch game fish, which mimic the natural movements of a baitfish when pulled along through the water by a user.

In preferred embodiments, the artificial fishing lures is configured to mimic how baitfish swim up in water to feed, then sinks while it feeds, and repeats the swim up as directed by the user. The swim up lure has a lure body mechanically coupled to a bill. A weight can be included within the lure body to ensure negative buoyancy to cause the lure body to fall slowly toward a bottom of the water.

In one approach, a swim up lure is configured to mimic how baitfish swim up in water to feed. The lure can have a lure body mechanically coupled to a bill; a weight configured within the lure body; wherein the weight is configured to cause the lure body to fall slowly toward a bottom of the water.

In another approach, an artificial gamefish lure is provided that can have a negatively buoyant body; and a bill attached to a front end of the lure body, the bill extending forward and upward of the lure body; wherein the lure is configured to sink in water until a horizontal force pulls the lure forward.

In one approach, the lure body can be rounded about its longitudinal axis with a rounded taper to the rear and a rounded front. Optionally, bottom side of the lure can be flat, whereby its ability to rise to the surface when retrieved is assisted.

In other embodiments, the lure can optionally have at least one hook and an attachment point for a fishing line.

In one approach, the negatively buoyant body can be configured to sink in fresh water at a rate of 30.5 cm in 2-5 seconds. The lure can also include an optional weight rearward of a horizontal center of mass and below vertical center of mass of the body.

According to one approach, the bill can be mounted on an axis on the top front of the lure body at an angle between 25 and 35 degrees from the horizontal line and extending forward and upward from the front of the lure body. The proportion of a bill width to a lure body width can be in the range of 0.8:1 to 1.3 to 1 and the proportion of a bill length to lure body length can be in the range of 0.2:1 to 0.7 to 1.

A method of capturing a gamefish with an artificial lure is also provided and can have the steps of, in order, providing a lure having a negatively buoyant body, a bill attached to a front end of the lure body, the bill extending forward and upward of the lure body, at least one hook attached to the body, and a retrievable line attached to the lure; casting the lure over a body of water allowing it to sink at a rate of 30.5 cm in 2-5 seconds to a sunken position; retrieving the lure from the sunken position at a rate of ascent in the range of 20 to 50 degrees relative to the surface of the water; skimming the lure across the surface to create ripples; and allowing the lure to sink to the sunken position.

These and other objects of the embodiments will become more apparent in the further description and drawings.

### BRIEF DESCRIPTION OF THE FIGURES

The detailed description of some embodiments of the invention is made below with reference to the accompanying figures, wherein like numerals represent corresponding parts of the figures, and wherein:

FIG. 1 is perspective view of a lure according to an embodiment of the invention;

FIG. 2 is a side elevation view of the embodiment of FIG. 1;

FIG. 3 is a section detail view taken along line III-III in FIG. 1 demonstrating an optional weight;

FIG. 4 is a top view of the embodiment of FIG. 1;

FIG. 5 is a bottom view of the embodiment of FIG. 1;

FIG. 6 is a front elevation view of the embodiment of FIG. 1;

FIG. 7 is a schematic view of the embodiment of FIG. 1 demonstrating usage in initial cast stage;

FIG. 8 is a schematic view of the embodiment of FIG. 1 demonstrating usage in sink stage;

FIG. 9 is a schematic view of the embodiment of FIG. 1 demonstrating usage in reel-in stage;

FIG. 10 is a schematic view of the embodiment of FIG. 1 demonstrating in emergence stage;

FIG. 11 is a schematic view of the embodiment of FIG. 1 demonstrating usage in sink stage;

FIG. 12 is a bottom view of a lure according to an alternate embodiment showing attached hooks and indicia;

FIG. 13 is a top view of the embodiment of FIG. 12; and

FIGS. 14-18 show elevation views of alternate embodiments of a bill and a line connecter.

### DETAILED DESCRIPTION

The embodiments herein relate generally to equipment configured to catch game fish, and particularly to artificial fishing lures (“lures”) used to catch game fish, which mimic the natural movements of a baitfish when pulled along through the water by a user. The present lure embodiments provide features unknown in the art, such as mimicking the action of baitfish during its feeding, which is to swim up to feed on the surface and then float down as it consumes whatever has been captured on the surface. The cycle is repeated as desired by the user. The present embodiments solve this deficiency in the art.

Large-mouth bass, a favorite game fish in the United States, have eyes located on the top of their heads. Thus, bass can have a very difficult time seeing prior art bottom-running artificial lures, such as a conventional plastic worm dragged along the bottom. In this instance, a bass attempting to look at a bait worm being worked across the bottom has to position its body almost vertical, tail up . . . head down, to see the bait. A baitfish is small fish (as a golden shiner or menhaden) that attracts a larger game fish as a food source. Baitfish is a favorite food of largemouth bass. Baitfish can be seen more easily by the bass with the sky as a background. Also, bass can see the ripples caused by baitfish as it feeds along the surface of the water. This is true even when the surface water is choppy. The ripples are still being created and the bass can see them and they know that the ripples are caused by the baitfish.

When a bass is feeding, it can remain motionless at or near the bottom of the lake or pond. During this time, the bass can look for the three types of motion that a baitfish exhibits during its own feeding cycle. First, baitfish normally take cover when not feeding, and have to swim up to the surface to feed, thus exposing themselves to attack. Game fish, such as bass and crappie, interpret motion of the baitfish, as trying to escape them, thus provoking a strike. Second, once a baitfish reaches the surface, it skims along the surface looking for food. As the baitfish's ripples pass over the bass, often they turn and move in the direction of the source, looking for food. And thirdly, baitfish are also vulnerable on their slow descent from the surface, while consuming their catch from the surface.

Given this knowledge of the behavior of the baitfish, and its perception by the game fish, the present lure embodiments are configured to allow a game fish, such as a large-mouth bass, three opportunities to attack the lure. Those opportunities being while the lure ascends, while it is dragged across the surface, and while it descends. Accordingly, the present embodiments provide a lure and method that can mimic all three aforementioned states of motion of a feeding baitfish.

Generally, the lure has a negative buoyant body having one or more hooks attached thereto and a bill at its front end to act as a “wing” to raise the lure toward the surface as it is pulled through the water by a user.

The body can be manufactured in several shapes and made from a variety of firm water-insoluble materials such metal, plastic, wood, composites, or any other firm material or combinations of materials. The most preferred body shape is a rounded body about its longitudinal axis with a rounded taper to the rear and a rounded front.

The present lure needs to be heavier than water. In other words, it must have negative buoyancy to allow it to automatically sink, unless acted upon to the user. To achieve negative buoyancy, the lure has to be made from a material that is less buoyant than water or have an added weight. Preferably, the lure will have a shape and buoyancy to sink in fresh water at a rate of one foot in 2-5 seconds (about 30.5 cm in 2-5 seconds).

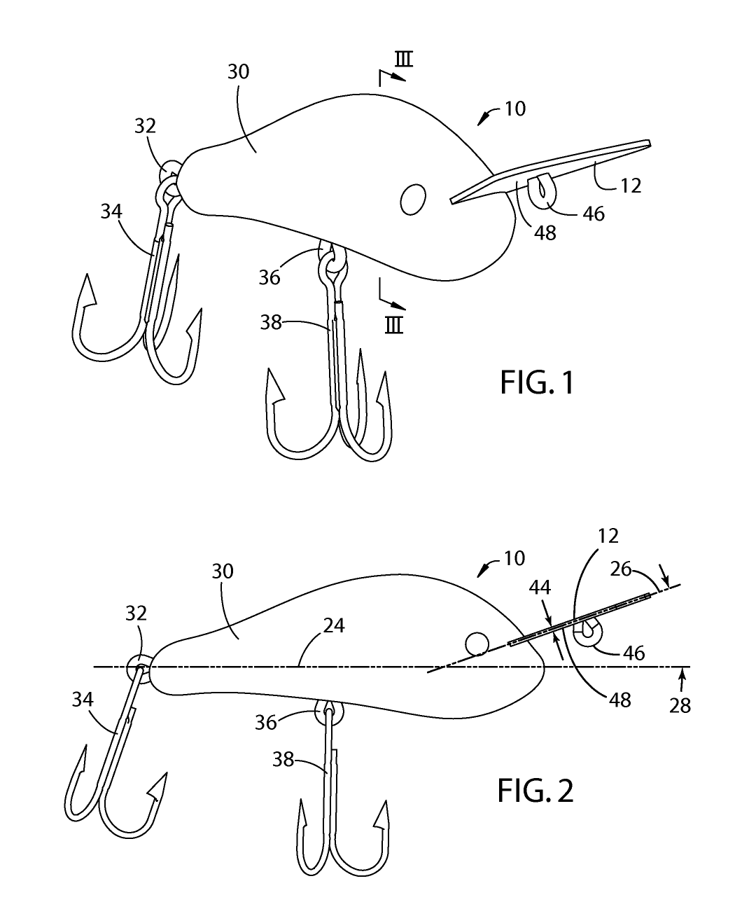

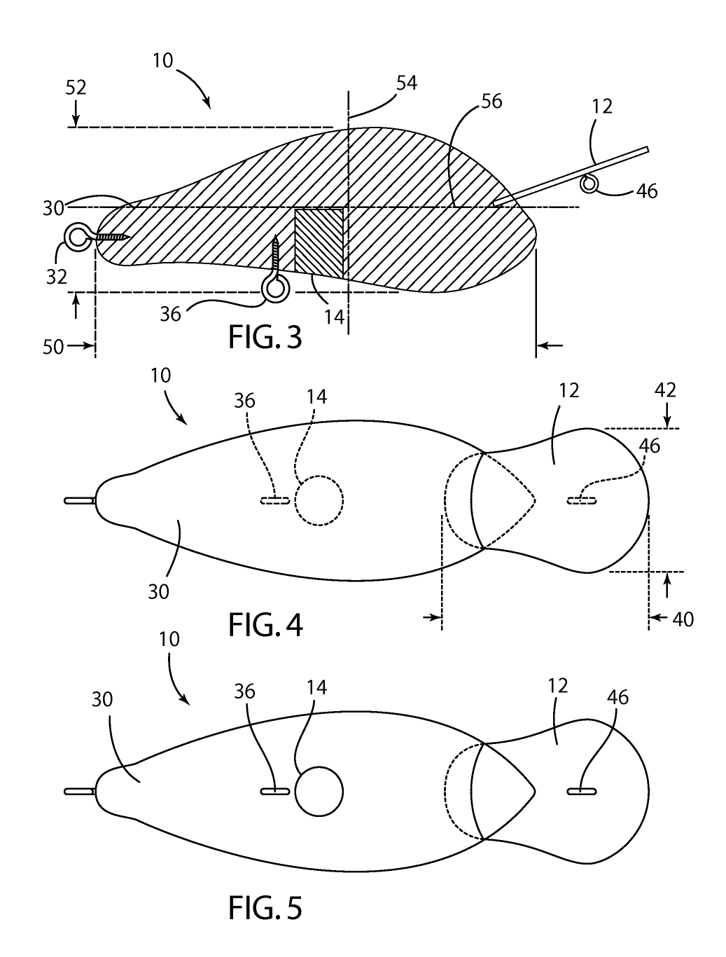

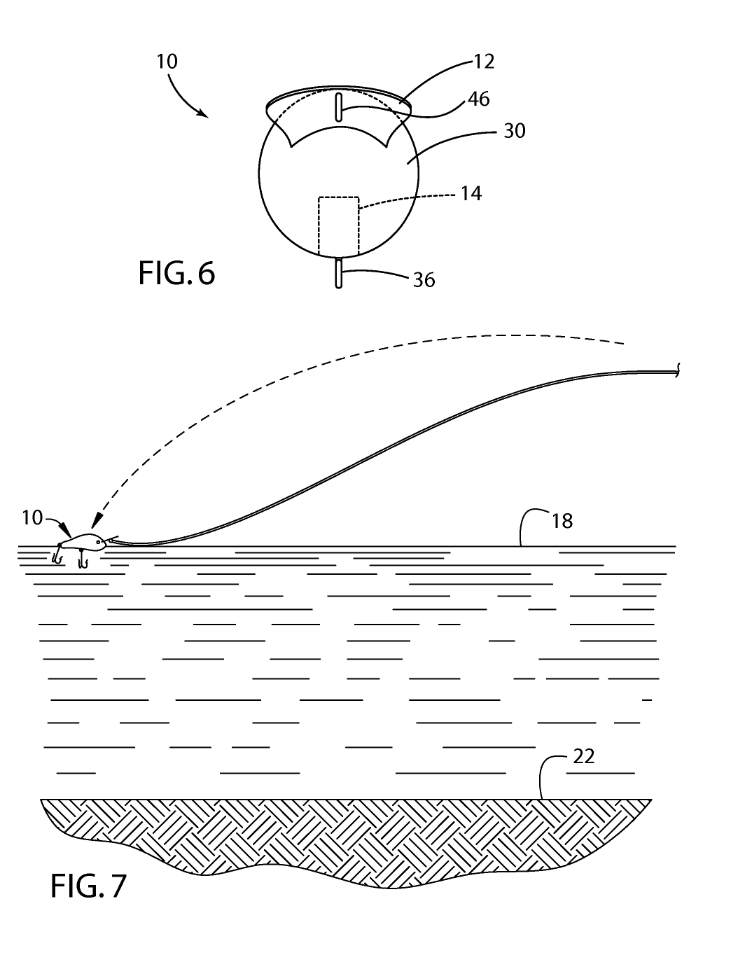

Referring to FIGS. 1-6, one embodiment of the present lure is generally indicated at 10. Lure 10 has a body 30 mechanically coupled to bill 12. The bottom side of body 30 can be flat to assist in its ability to rise to the surface when retrieved. Body 30 can have a length 50 in a range from two inches (5 cm) long to eight inches (20 cm) long. Body 30 can have a height 52 in a range from 0.25 inches (0.6 cm) to two inches (5 cm) long. (See FIG. 3).

In some embodiments body 30 can be made of and/or include positive buoyant materials such as wood or hollow plastic component. In these instances, the desired amount of negative buoyancy can be achieved by an added weight 14, as shown, for example, in FIG. 3. As shown in FIG. 3 a portion of body 30 is hollowed out and replaced with weight 14. Preferably, weight 14 is rearward and downward of the center of mass of lure body 30 in order to permit lure 10 to rise and fall in a flat orientation. As shown in FIG. 3, weight 14 is oriented rearward of a horizontal center of mass 54 and below vertical center of mass 56 of body 30. In some embodiments, lure body 30 can also be made or and/or include negatively buoyant material, such as glass, metal, or a composite which would eliminate the need for weight 14 being inserted into lure body 30. This sinking motion achieves the third motion of the feeding baitfish described above.

As illustrated in the figures, lure body 30 can have one or more fishing hooks to snare the game fish. As shown in FIG. 1, hooks 34 and 38 can be made of any hook metals known in the art and can be double or triple hooks and in sets of one, two or three. As illustrated in FIGS. 1 and 2, hooks 34 and 38, can be attached to lure body 30 by hook connectors 32 and 36 respectively. Again it is noted that the number and placement of hooks is dependent on lure 10 to be able rise, skim and fall as described herein as well as to provide the properly attached the game fish to the lure to allow the fisherman to retrieve.

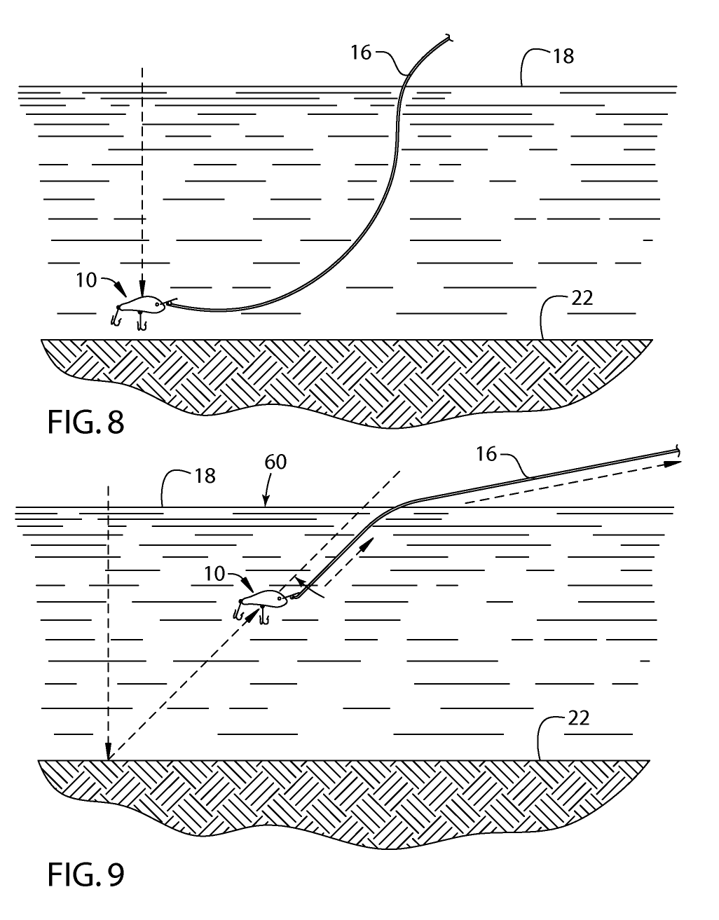

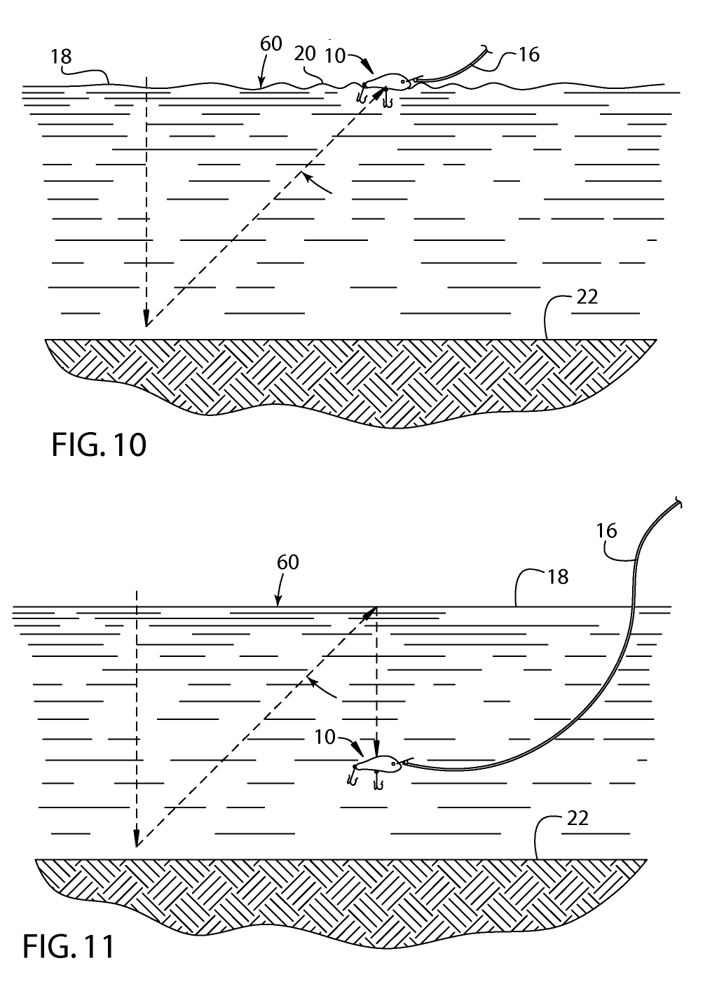

Coupled to the front of lure body 30 is a bill 12, which acts as a “wing” to raise the sinking lure 10 when the fisherman retrieves the lure 10 by providing a horizontal force. Bill 12 provides the mimic of the first described motion of the baitfish to rise to the surface to look for food. Although the present embodiment of the invention is illustrated with a somewhat “diamond-shaped” bill 12, it is noted that bill 12 can be configured in a variety of shapes, materials and thicknesses so long as they are of a variety and size to allow lure 10 to rise at a 20 to 50 degree angle in relation to the surface of the water (see angle 60, FIGS. 9-11), irrespective of the rate of speed that line 16 is retrieved by a user. Thus, in use, the faster the retrieval of the lure, the greater the angle of ascent—up to 50 degrees. In other words, lure 10 will rise at a rate in direct proportion to the speed the angler (user) is turning the reel to retrieve the fishing line. Thus, slower retrieval means slower speed of rise (20 degrees) and faster retrieval means a faster speed of rise (up to 50 degrees). Once the lure has risen to the surface, the user can continue a horizontal force on the lure to allow it to skim the surface of the water, thus providing the ripples to mimic the second motion described above for the baitfish.

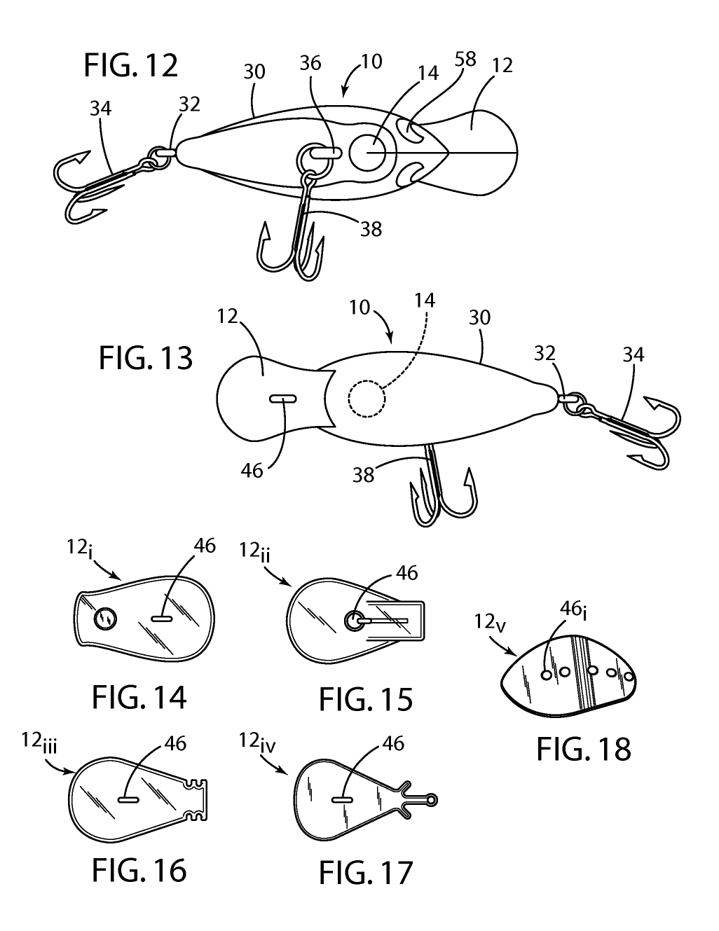

Again, as for the shape of bill 11, any number of designs will work, depending on the size of the lure 10, the shape, the amount of weight added and the buoyancy of the lure body 30. Alternate embodiments of bill 12 are shown by way of example in FIGS. 12-18.

In the present embodiments, bill 12 may be made from metal, plastic, wood, any other firm water-insoluble material, and combinations thereof. If a horizontal line or longitudinal axis of the body 30 of the lure 10 is established by drawing an imaginary line from the forward tip of the lure 10 to the center of the rear end of the lure 10 (illustrated at 24 in FIG. 1), bill 12 is preferably mounted on an axis 26 on the top front of lure body 30 at an angle 28 between 25 and 35 degrees from the horizontal line or longitudinal axis 24 and extending forward and upward from the front of the lure body 30.

The bill 12 can have a bill width 42 anywhere between ⅝ inches (1.5 cm) wide up to more than two inches (5 cm) wide. Bill 12 can also have a bill length 40, which can be from ¾ inch (1.9 cm) long up to four inches (10 cm) long. Length 40 and width 42 of bill 12 (FIG. 4) can be related by proportion determined based on the desired dimensions of lure body, which can be determined through use. Generally though, the proportion of bill width 42 to lure body width 52 can be in the range of 0.8:1 to 1.3 to 1. The proportion of bill length 40 to lure body length 50 can be in the range of 0.2:1 to 0.7 to 1. Bill 12 can have a bill thickness 44 (FIG. 2), which can be from one-thirty-seconds inch (0.07 cm) to one-fourth inch (0.63 cm), again depending on the size of the lure body 30. Bill 12 can also be manufactured with a base thicker at the nose of the lure descending in thickness towards the leading edge of the lure 10. In all of the preferred embodiments, the bill 12 is located above the center longitudinal axis (e.g., on the top half of the body) to allow the lure 10 to be guided to the surface when retrieved by a user and to descend as described below.

Additionally, a line connecter “eyelet” 46 for attaching line 16 that is presently illustrated on the underside/bottom 48 of bill 12, could also be located on the front of lure body 30.

Additional features can also be provided to the present embodiments. An eyelet line connector 46 is shown in FIG. 1, where line 16 or optional swivel attaches to lure body 30 can be mounted either on the bottom side 48 of bill 12 or on the very front of the lure. Optional coloration and graphic indicia 58 (FIG. 12) can be added by the lure manufacturer for areas where they plan to market this lure depending upon what kind of bait is preferred for game fish in their particular geographic marketplace.

The three exemplary motions of the present lure to mimic a feeding baitfish are shown in one sequence in FIGS. 7-11. As shown in FIG. 7, lure 10 is cast onto water surface 18 where the lure 10 proceeds to sink toward bottom 22 at a rate described above. This movement of the lure 10 thus mimics the third motion of the baitfish consuming its surface catch. As a user provides a horizontal force by reeling in line 16, lure 10 is pulled upward toward the surface of water 18 through the wing effect of bill 12, as shown in sequence in FIGS. 9-11. Unlike conventional lures, which are pulled toward the user, lure 10 heads toward the surface of water 18 at an angle of between 20 to 50 degrees irrespective of the angle of pull by the user.

It is noted that in FIG. 9, the angle of ascent is greater than the angle of retrieval by line 16. Thus, the second motion of the baitfish to rise to the surface in search of food is accomplished. Upon reaching the surface, lure body 30 will continue to skim across the water's surface 18 by the continued retrieval of line 16 by the user. This motion will create ripple 20 and thus the second motion of the baitfish skimming the water surface 18 looking for food is accomplished. And finally, as shown in FIG. 11, once the user allows line 16 to go slack, lure 10 again sinks to the bottom at a rate described above mimicking the baitfish consuming his food. In short the following method with the present lure of rising, surface skimming and falling accurately mimics a feeding baitfish.

Persons of ordinary skill in the art may appreciate that numerous design configurations may be possible to enjoy the functional benefits of the described embodiments. Thus, given the wide variety of configurations and arrangements of the present embodiments, the scope of the invention is reflected by the breadth of the claims below rather than narrowed by the embodiments described above.

I claim:

1. A swim up lure, configured to mimic how baitfish swim up in water to feed, the swim up lure comprising:
a lure body mechanically coupled to a bill;
a weight configured within the lure body;
wherein the weight is configured to cause the lure body to fall slowly toward a bottom of the water.

2. An artificial gamefish lure, the lure comprising:
a negatively buoyant lure body; and
a bill attached to a front of the lure body, the bill extending forward and upward of the lure body;
wherein the lure is configured to sink in water until a horizontal force pulls the lure forward.

3. The lure of claim 2, wherein the lure body is rounded about a longitudinal axis of the lure body, the lure body having a rounded taper toward a rear of the lure body and a rounded front.

4. The lure of claim 3, wherein a bottom side of the lure body is flat to facilitate an ability of the lure body to rise to a water surface when the lure is retrieved by a user.

5. The lure of claim 2, further comprising at least one hook and an attachment point for a fishing line.

6. The lure of claim 2, wherein the negatively buoyant lure body is configured to sink in fresh water at a rate of 30.5 cm in 2-5 seconds.

7. The lure of claim 6, further comprising a weight rearward of a horizontal center of mass of the lure body and below a vertical center of mass of the lure body.

8. The lure of claim 2, wherein the bill is mounted on an axis on a top of the front of the lure body at an angle between 25 and 35 degrees from a longitudinal axis of the lure body and extending forward and upward from the front of the lure body.

9. The lure of claim 8, wherein a proportion of a bill width to a lure body width is in a range of 0.8:1 to 1.3 to 1 and a proportion of a bill length to a lure body length is in the range of 0.2:1 to 0.7 to 1.

10. A method of capturing a gamefish with an artificial lure, the method comprising:
providing a lure having a negatively buoyant body, a bill attached to a front of the lure body, the bill extending forward and upward from the lure body, at least one hook attached to the body, and a retrievable line attached to the lure;
casting the lure over a body of water allowing the lure to sink to a sunken position at a rate of 30.5 cm in 2-5 seconds;
retrieving the lure from the sunken position at a rate of ascent in the range of 20 to 50 degrees relative to the surface of the water;
skimming the lure across the surface to create ripples; and
allowing the lure to sink to the sunken position.
